(19) United States
(12) Patent Application Publication
(10) Pub. No.: US 2026/0109258 A1
(43) Pub. Date: Apr. 23, 2026

(54) ELECTRIC VEHICLE SUPPLY EQUIPMENT WITH VEHICLE-TO-LOAD POWER DELIVERY AND CONTROL PILOT SIGNAL CONTROL

(71) Applicant: Aptiv Technologies AG, Schaffhausen (CH)

(72) Inventors: Jeffrey S. KIKO, Kent, OH (US); Don Bizon, Boardman, OH (US); Jian ZHANG, Shanghai (CN)

(21) Appl. No.: 18/924,447

(22) Filed: Oct. 23, 2024

(51) Int. Cl. B60L 55/00; B60L 53/16; B60L 53/18; H02J 7/00

(52) U.S. Cl. CPC B60L 55/00; B60L 53/16; B60L 53/18; H02J 7/855

(57) ABSTRACT

The Electric Vehicle Supply Equipment (EVSE) described herein is designed for Vehicle-to-Load (V2L) power transfer, enabling the delivery of electrical power from an electric vehicle to an external electrical load. The EVSE includes an output connector for connecting to a vehicle connector via an output cord, an electronic controller, and a power supply. The power supply is capable of receiving a direct current (DC) control pilot signal transmitted through the vehicle connector via the output connector and supplying DC electrical power to the electronic controller based on the received control pilot signal. This innovative EVSE system facilitates efficient and controlled power transfer between electric vehicles and external loads, enhancing the versatility and functionality of electric vehicle charging infrastructure.

### TECHNICAL FIELD

The subject matter disclosed herein relates to electric vehicle supply equipment (EVSE) and, in particular, to EVSE with vehicle-to-load (V2L) power delivery and control pilot signal control.

### BACKGROUND

Previous approaches to Electric Vehicle Supply Equipment (EVSE) systems have primarily focused on delivering electrical power from an external power source to an electric vehicle for charging purposes. These conventional EVSE systems typically include an output connector designed to interface with a vehicle connector, allowing for the transfer of electrical power from the EVSE to the electric vehicle. The primary function of these traditional EVSE systems has been to facilitate the charging of electric vehicles by providing a means for transferring power from the grid to the vehicle's battery system.

In some instances, EVSE systems have incorporated electronic controllers to manage the flow of electrical power between the external power source and the electric vehicle. These controllers may be responsible for monitoring the charging process, adjusting power levels, and ensuring the safety and efficiency of the charging operation. Additionally, power supplies have been utilized in EVSE systems to convert the incoming electrical power from the grid into a form suitable for charging the electric vehicle's battery.

Furthermore, advancements in EVSE technology have led to the development of Vehicle-to-Load (V2L) capabilities, allowing electric vehicles to not only receive power for charging but also to supply electrical power to external loads.

Vehicle-to-load (V2L) charging is a bidirectional power feature that enables you to use the battery in an electric vehicle to power another device. While the vehicle is sitting idle, the battery is able to connect to other devices such as a phone charger, a kettle, and even another electric vehicle to transfer power to it. Essentially, compatible electric vehicles function as rechargeable power banks that you can use to charge another device-then, when the battery runs low, you can plug in the vehicle and charge it up again.

Vehicle-to-load technology relies on an onboard inverter to convert the direct current (DC) electricity stored in an electric vehicle's battery to alternating current (AC) electricity, which is used by most common appliances and devices. This functionality can be integrated into the existing on-board charger that converts AC to DC making it a bi-directional charger. An external adapter may be used with the electric vehicle's charging port; this provides a socket to directly plug in the AC devices, such as a phone charger, fan, or light. Some electric vehicles also have built-in AC sockets so an adapter to perform V2L charging may not be needed.

However, existing EVSE systems with V2L functionality have typically required separate components or systems to enable power transfer from the electric vehicle to external loads. These conventional approaches have often involved complex and inefficient setups, limiting the seamless integration of V2L capabilities into EVSE systems. However, none of these approaches have provided a comprehensive solution that combines the features described in this disclosure.

### SUMMARY

In some aspects, the techniques described herein relate to an Electric Vehicle Supply Equipment (EVSE) configured to deliver electrical power from an electric vehicle to an electrical load external to the electric vehicle (V2L), the EVSE including: an output connector configured to interface with an output cord terminated by a vehicle connector; an electronic controller; and a power supply configured to receive a direct current (DC) control pilot signal through the vehicle connector via the output connector and provide DC electrical power to the electronic controller based on the DC control pilot signal.

In some aspects, the techniques described herein relate to an input cord configured for use with Electric Vehicle Supply Equipment (EVSE), including: a receptacle conforming to ANSI/NEMA standard WD 6-2021, wherein the receptacle is selected from a list consisting of NEMA type 5-15, NEMA type 14-30, and NEMA type 14-50 receptacles; an EVSE connector configured to interface with an input connector of the EVSE; and a resistor connected to the EVSE connector having a value associated with the NEMA type 5-15, NEMA type 14-30, or NEMA type 14-50 receptacles.

In some aspects, the techniques described herein relate to a method of delivering electrical power from an electric vehicle to an electrical load external to the electric vehicle using an EVSE, the method including: transmitting a DC control pilot signal from the electric vehicle to the EVSE via an output cord terminated by a vehicle connector; waking an electronic controller of the EVSE from a dormant state after receiving the DC control pilot signal; and controlling the EVSE via the electronic controller to receive AC electrical power from the electric vehicle through the output cord and transmit AC electrical power to the electrical load external to the electric vehicle through an input cord terminated by an AC receptacle.

### BRIEF DESCRIPTION OF THE DRAWINGS

FIG. 1 is an isometric view of an electric vehicle supply equipment (EVSE) according to the prior art.

FIG. 2 is a schematic view of an electric vehicle, an external load, and an EVSE with vehicle-to-load (V2L) power delivery according to some embodiments.

FIG. 3 is an isometric view of an EVSE with V2L power delivery according to some embodiments.

FIGS. 4A, 4B, and 4C are isometric views of input cords of the EVSE with V2L power delivery of FIG. 2 with various receptacle types according to some embodiments.

FIG. 5 is a schematic electrical diagram of the EVSE with V2L power delivery of FIG. 2 according to some embodiments.

FIG. 6 is a process diagram of a method of delivering electrical power from an electric vehicle to an electrical load external to the electric vehicle using an EVSE with V2L power delivery according to some embodiments.

### DETAILED DESCRIPTION

FIG. 1 shows an isometric view of an electric vehicle supply equipment (EVSE 100) according to the prior art configured to operate in Mode 2, i.e., provide electrical power to an electric vehicle for charging a battery in the electric vehicle. As configured to operate in Mode 2, the EVSE 100 includes a vehicle connector 102 designed to connect the EVSE 100 to an electric vehicle. The vehicle connector 102 is connected to an output connector 106 of an electronic controller 104 by an output cord 108. The output connector 106 may be configured to be separable, e.g., including pins and or receptacles. Alternatively, the output connector 106 may be configured to be non-separable, e.g., including wires that are soldered to a circuit board. output cord 108. The EVSE 100 also includes a separable input cord 110 configured to be connected to the electronic controller 104 by an input connector 112 and terminated by a plug connector 114 configured to mate with a receptable connector which supplies AC electrical power to the EVSE 100. There may be several different versions of the input cord 110 having different plug connectors to a allow the EVSE 100 to interface with a variety of different receptable connector types.

In Mode 2, the electronic controller 104 receives AC electrical power through the input cord 110. The electronic controller 104 also sends a control pilot signal in the form of a 1 kHz square wave to the vehicle connector 102 via the output cord 108 and the vehicle requests charge by changing the positive pilot voltage from 9V to 6 VDC which causes the electronic controller 104 to command the EVSE 100 to pass AC electrical power from the plug connector 114 though the input cord 110, the output cord 108, and the vehicle connector 102 to the electric vehicle.

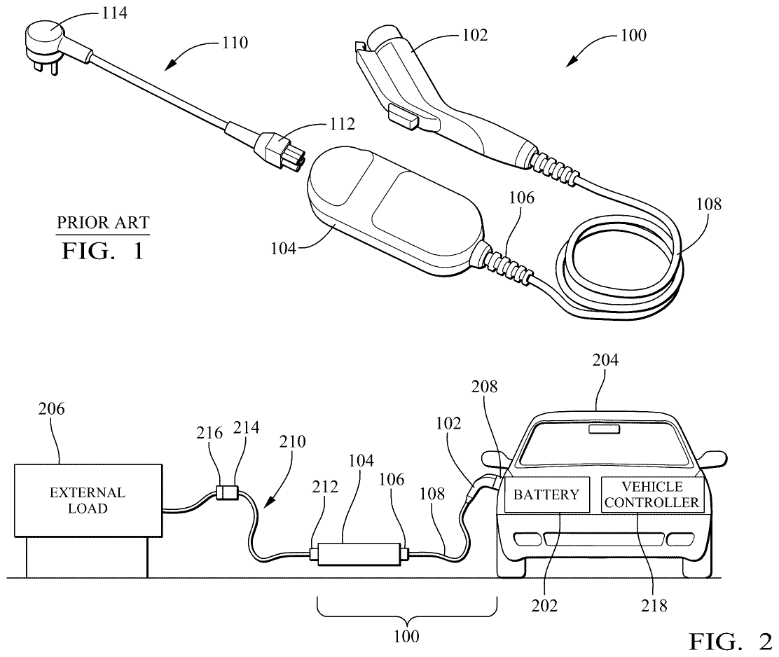

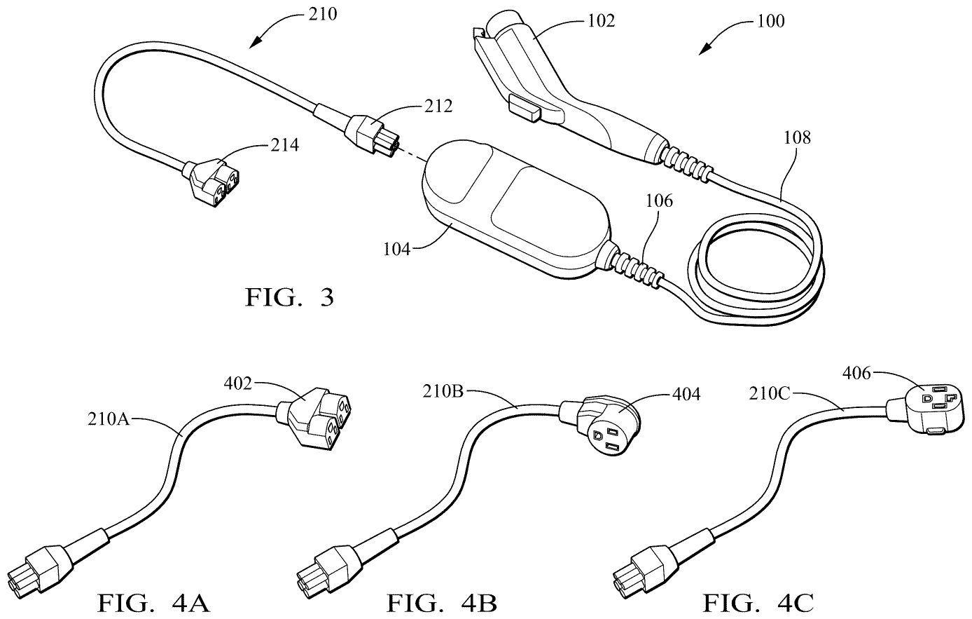

FIGS. 2 and 3 shows the EVSE 100 configured to provide vehicle-to-load (V2L) power connected to an electric vehicle and supplying electrical power from an electric vehicle to an electrical load external to the electric vehicle. In V2L mode, the EVSE 100 is configured to transfer electrical power from a battery 202 of an electric vehicle 204 to an electrical load 206 external to the electric vehicle 204. The EVSE 100 includes a vehicle connector 102 configured to connect the EVSE 100 to a charge port 208 of the electric vehicle 204. The vehicle connector 102 is connected to the output connector 106 of the electronic controller 104 by the output cord 108. When using the EVSE 100 in V2L mode, the input cord 110 having a plug connector 114 is replaced by a separable input cord 210 configured to be connected to the electronic controller 104 by an input connector 212 and terminated by a receptacle connector 214 configured to mate with a plug connector 216 which supplies AC electrical power from the electric vehicle 204 to the electrical load 206.

There may be several different configurations of the input cord 210 having different receptacle connectors as shown in FIGS. 4A, 4B, and 4C to allow the EVSE 100 to interface with a variety of different plug connector types. FIG. 4A illustrates an input cord 210A configured to transmit 120 V AC power at a current up to 15 amperes which is terminated by a pair of NEMA type 5-15 receptacles 402. FIG. 4B illustrates an input cord 210B configured to transmit 240 V AC power at a current up to 30 amperes which is terminated by a NEMA type 14-30 receptacle 404. FIG. 4C illustrates an input cord 210C configured to transmit 240 V AC power at a current up to 50 amperes which is terminated by a NEMA type 14-50 receptacle 406. These NEMA receptacles are used primarily in North America. Other input cord configurations for use in other regions having different receptacles, e.g., Europlug CCE 7/16, British Standard (BS) 1363, Australian/New Zealand Standard AS/NZS 3112, or Chinese PPCS-CCC technical standards, may also be envisioned.

To initiate V2L power transfer, a vehicle controller 218 in the electric vehicle 204 transmits a DC control pilot signal rather than the 1 kHz square wave control pilot signal to the EVSE 100 via the charge port 208. This DC control pilot signal flows to the electronic controller 104 via the vehicle connector and output cord, thereby powering the electronic controller 104 and waking it from its dormant state. The control pilot signal powers the electronic controller 104 since, in this configuration, the electronic controller 104 cannot receive electrical power through the input cord since the input cord is connected to the electrical load 206 rather than an electrical power supply.

The DC control pilot signal has one of a number of predetermined voltage that indicate the input cord configuration, an example of which is shown in Table 1 below:

TABLE 1
DC Pilot Voltages

| Receptacle Type | DC Pilot Voltage |
|---|---|
| NEMA 5-15 | +12 V |
| NEMA 14-30 | +15 V |
| NEMA 14-50 | +18 V |

The input cords 210A, 210B, 210C each include a coding resistor having a value indicative of the receptacle type. The electronic controller 104 is configured to determine this resistance value and confirm whether the receptacle type associated with this resistance value matches the receptacle type indicated by the DC control pilot signal. If the receptacle types match, then the electronic controller will close switches allowing electrical power to flow from the electric vehicle to the external load. If the receptable types do not match, then the electronic controller will keep the switches open, thereby preventing electrical power from flowing from the electric vehicle to the external load until the correct input cord is attached.

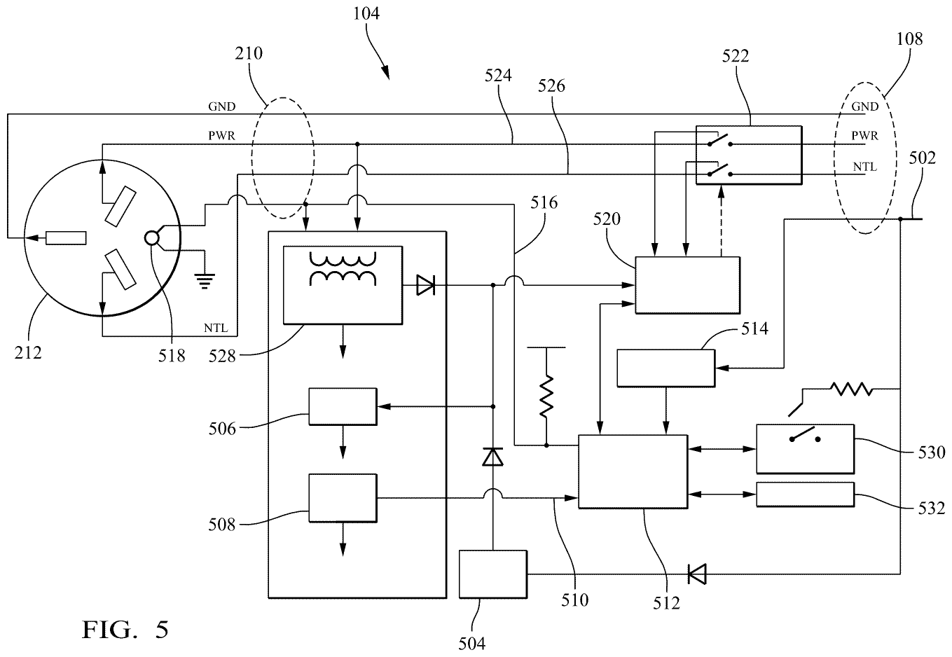

FIG. 5 shows an electrical schematic diagram of the electronic controller 104. The electronic controller 104 receives the DC control pilot signal 502 from the vehicle controller 218 via the output cord 108. In this example, a DC/DC boost convertor 504, DC/DC buck convertor 506, and DC voltage regulator 508 provide a proper DC power supply 510 to an MCU module 512. In alternative embodiments, different circuitry may be used to convert the DC control pilot signal to the proper DC power supply 510 for the MCU module 512. The DC control pilot signal 502 is also sent to a control pilot signal voltage monitor circuit 514 communicating with the MCU module 512 that allows the MCU module 512 to determine the expected receptacle type of the input cord 210. The electronic controller 104 also contains an input cord sensor circuit 516 connected to the coding resistor 518 in the receptacle connector 212 of the input cord 210 that allows the MCU module 512 to verify that the input cord 210 attached to the electronic controller 104 matches the expected receptacle type indicated by the DC control pilot signal 502. If the receptacle types match, the MCU module 512 commands a relay control module 520 to close a relays 522 power and neutral lines 524, 526 to send electrical power from the electric vehicle 204 to the electrical load 206 via the output cord 108, the electronic controller 104, and the input cord 210. If the receptacle types do not match, the MCU module 512 will not allow the relays 522 to energize, thereby preventing electrical power from the electric vehicle 204 from being sent to the input cord 210. The EVSE 100 may also be configured to indicate that the receptacle types do not match, for example by illuminating a warning indicator.

The AC to DC transformer 528 shown in FIG. 5 provides electrical power to the MCU module 512 and the control pilot module 530 provides the 1 kHz square wave control pilot signal when the EVSE 100 is operating in Mode 2. The EVSE 100 may also include a LIN transceiver 532 configured to communicate with external devices, e.g., the vehicle controller 218.

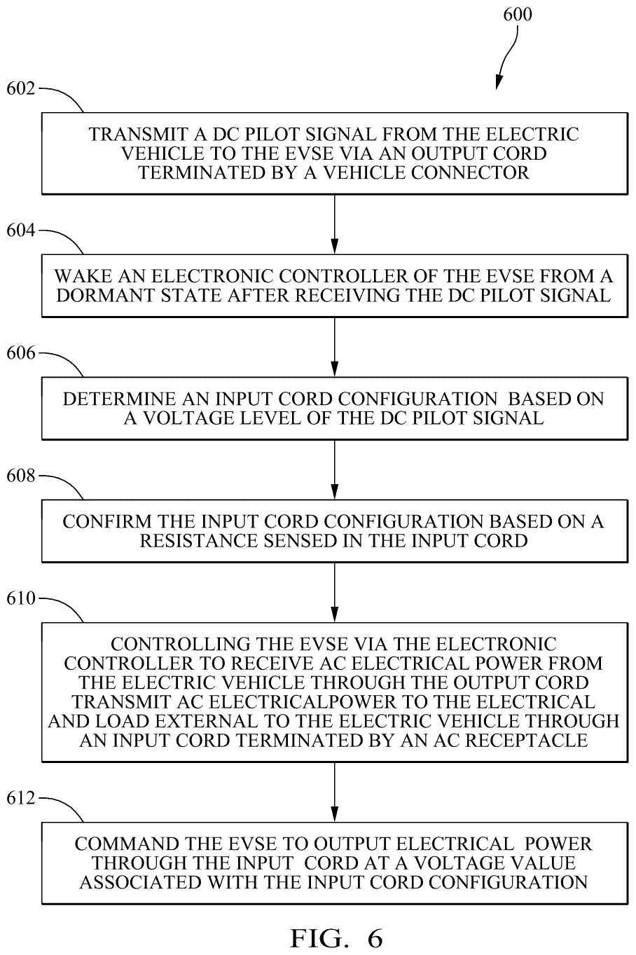

FIG. 6 shows a flow chart of a method 600 of delivering electrical power from an electric vehicle to an electrical load external to the electric vehicle using an EVSE, such as the EVSE 100 described above.

In step 602, a DC control pilot signal 502 is transmitted from an electric vehicle 204 to an EVSE 100 via an output cord 108 terminated by a vehicle connector 102.

In step 604, the DC control pilot signal 502 wakes an electronic controller 104 of the EVSE 100 from a dormant state after receiving.

In step 606, the electronic controller 104 determines an input cord configuration based on a voltage level of the DC control pilot signal.

In step 608, the electronic controller 104 confirms the input cord configuration based on the coding resistor 518 sensed in the input cord 210.

In step 610, the electronic controller 104 controls the EVSE 100 via to receive AC electrical power from the electric vehicle 204 through the output cord 108 and transmit AC electrical power to an electrical load 206 external to the electric vehicle 204 through an input cord 210 connected to the electronic controller 104 and terminated by the receptacle connector 212.

In step 612, the EVSE 100 is commanded by the electronic controller 104 to output electrical power through the input cord 210.

The EVSE 100 presented herein provides a bi-directional charger with alternate exchangeable input cords 210A, 210B, 210C that give the user with a receptable of their choice in place of the traditional plug that interfaces to a wall socket to enable V2L applications. This disclosure presents a simplified method for the EVSE 100 to communicate the type of receptacle selected by the user to the charging cord set and enable the proper verification of the mated corded receptacle.

EVSE 100 replaces existing exchangeable grid cords 110 with plug terminations with exchangeable grid cords 210 with receptacle terminations that support vehicle-to-load (V2L) charging applications. There may be a need for the EVSE 100 to communicate the specific type of receptacle the user selects to ensure that the proper voltage and current is provided by the electric vehicle 204.

This disclosure presents a basic method of communicating the proper AC receptacle type whereby the vehicle controller 218 asserts some number of discrete positive DC voltages on the control pilot signal 502 to indicate to the input cord 210 to be used. The electronic controller 104 monitors the voltage of the control pilot signal 502 and decodes the voltage present. This exchange of receptacle type information is important so that the electronic controller 104 can confirm the proper input cord 210 is mated to the electronic controller 104 and safely operate the EVSE 100 by ensuring the correct voltage and current is supplied by the EVSE 100. This also enhances safety by preventing the electronic controller 104 from energizing an improper input cord with a plug, e.g. input cord 110. These input cords 210A, 210B, 210C use resistor-coding as the method of identification. Each corded receptacle will incorporate a unique resistor which will be monitored by the electronic controller 104 and compared to the intended receptacle information communicated on the control pilot signal 502 from the vehicle controller 218.

This simplified method of communication using only the control pilot signal also allows the number of conductors in the output cord 108 to be minimized to just four conductors, a power conductor, a neutral conductor, a ground conductor, and a control pilot conductor. Some other V2L solutions require a fifth conductor in the output cord 108 set to monitor a proximity signal.

### Discussion of Possible Embodiments

The following are non-exclusive descriptions of possible embodiments of the present invention.

In some aspects, the techniques described herein relate to an Electric Vehicle Supply Equipment (EVSE) configured to deliver electrical power from an electric vehicle to an electrical load external to the electric vehicle (V2L), the EVSE including: an output connector configured to interface with an output cord terminated by a vehicle connector; an electronic controller; and a power supply configured to receive a direct current (DC) control pilot signal through the vehicle connector via the output connector and provide DC electrical power to the electronic controller based on the DC control pilot signal.

The EVSE of the preceding paragraph can optionally include, additionally and/or alternatively any, one or more of the following features/steps, configurations and/or additional components.

In some aspects, the techniques described herein relate to an EVSE, further including an input connector configured to interface with an input cord terminated by an alternating current (AC) plug or an AC receptacle.

In some aspects, the techniques described herein relate to an EVSE, wherein the electronic controller is configured to wake up from a dormant state after receiving the DC control pilot signal and control the EVSE to receive AC electrical power through the output connector and transmit AC electrical power through the input connector.

In some aspects, the techniques described herein relate to an EVSE, wherein the electronic controller is configured to wake up from a dormant state after receiving electrical power from an electrical power supply via the input connector and control the EVSE to receive AC electrical power through the input connector and transmit AC electrical power through the output connector.

In some aspects, the techniques described herein relate to an EVSE, wherein the input cord includes one of a plurality of input cord configurations.

In some aspects, the techniques described herein relate to an EVSE, wherein the electronic controller is further configured to: determine an input cord configuration based on a voltage level of the DC control pilot signal, confirm the input cord configuration based on a resistance sensed in the input cord, and command the EVSE to output electrical power through the input connector.

In some aspects, the techniques described herein relate to an EVSE, wherein the DC control pilot signal has one of a set of predetermined set of voltage levels.

In some aspects, the techniques described herein relate to an EVSE, wherein the input cord is configured to conduct 120 to 240 volts and 15 to 50 amperes.

In some aspects, the techniques described herein relate to an EVSE, further including the input cord which includes a receptacle conforming to ANSI/NEMA standard WD 6-2021, wherein the receptacle is selected from a list consisting of NEMA type 5-15, NEMA type 14-30, and NEMA type 14-50 receptacles.

In some aspects, the techniques described herein relate to an EVSE, wherein the input cord includes a resistor having a value associated with NEMA receptacle type 5-15, 14-30, or 14-50.

In some aspects, the techniques described herein relate to an EVSE, wherein the input cord includes a pair of NEMA type 5-15 receptacles.

In some aspects, the techniques described herein relate to an EVSE, further including the vehicle connector and the output cord, wherein a plurality of wires in the output cord connecting the vehicle connector to the output connector consists of a power wire, a neutral wire, a ground wire, and a control pilot signal wire.

In some aspects, the techniques described herein relate to an input cord configured for use with Electric Vehicle Supply Equipment (EVSE), including: a receptacle conforming to ANSI/NEMA standard WD 6-2021, wherein the receptacle is selected from a list consisting of NEMA type 5-15, NEMA type 14-30, and NEMA type 14-50 receptacles; an EVSE connector configured to interface with an input connector of the EVSE; and a resistor connected to the EVSE connector having a value associated with the NEMA type 5-15, NEMA type 14-30, or NEMA type 14-50 receptacles.

The input cord of the preceding paragraph can optionally include, additionally and/or alternatively any, one or more of the following features/steps, configurations and/or additional components.

In some aspects, the techniques described herein relate to an input cord, wherein the input cord includes a pair of NEMA type 5-15 receptacles.

In some aspects, the techniques described herein relate to a method of delivering electrical power from an electric vehicle to an electrical load external to the electric vehicle using an EVSE, the method including: transmitting a DC control pilot signal from the electric vehicle to the EVSE via an output cord terminated by a vehicle connector; waking an electronic controller of the EVSE from a dormant state after receiving the DC control pilot signal; and controlling the EVSE via the electronic controller to receive AC electrical power from the electric vehicle through the output cord and transmit AC electrical power to the electrical load external to the electric vehicle through an input cord terminated by an AC receptacle.

The method of the preceding paragraph can optionally include, additionally and/or alternatively any, one or more of the following features/steps, configurations and/or additional components.

In some aspects, the techniques described herein relate to a method, further including determining an input cord configuration based on a voltage level of the DC control pilot signal, confirming the input cord configuration based on a resistance sensed in the input cord and commanding the EVSE to output electrical power through the input cord.

In some aspects, the techniques described herein relate to a method, further including selecting the input cord from a plurality of input cord configurations each having a receptacle conforming to ANSI/NEMA standard WD 6-2021, wherein the receptacle is a NEMA type 5-15, NEMA type 14-30, or NEMA type 14-50 receptacle.

In some aspects, the techniques described herein relate to a method, wherein only a neutral conductor, a power conductor, a ground conductor, and a control pilot signal conductor of an output cable connecting the EVSE to the electric vehicle are used to deliver the electrical power from the electric vehicle to the electrical load external to the electric vehicle.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. An Electric Vehicle Supply Equipment (EVSE) configured to deliver electrical power from an electric vehicle to an electrical load external to the electric vehicle (V2L), the EVSE comprising:
an output connector configured to interface with an output cord terminated by a vehicle connector;
an electronic controller; and
a power supply configured to receive a direct current (DC) control pilot signal through the vehicle connector via the output connector and provide DC electrical power to the electronic controller based on the DC control pilot signal.

2. The EVSE according to claim 1, further comprising an input connector configured to interface with an input cord terminated by an alternating current (AC) plug or an AC receptacle.

3. The EVSE according to claim 2, wherein the electronic controller is configured to wake up from a dormant state after receiving the DC control pilot signal and control the EVSE to receive AC electrical power through the output connector and transmit AC electrical power through the input connector.

4. The EVSE according to claim 3, wherein the electronic controller is configured to wake up from a dormant state after receiving electrical power from an electrical power supply via the input connector and control the EVSE to receive AC electrical power through the input connector and transmit AC electrical power through the output connector.

5. The EVSE according to claim 2, wherein the input cord comprises one of a plurality of input cord configurations.

6. The EVSE according to claim 5, wherein the electronic controller is further configured to:
determine an input cord configuration based on a voltage level of the DC control pilot signal,
confirm the input cord configuration based on a resistance sensed in the input cord, and
command the EVSE to output electrical power through the input connector.

7. The EVSE according to claim 6, wherein the DC control pilot signal has one of a set of predetermined set of voltage levels.

8. The EVSE according to claim 2, wherein the input cord is configured to conduct 110 to 240 volts and 15 to 50 amperes.

9. The EVSE according to claim 2, further comprising the input cord which comprises a receptacle conforming to ANSI/NEMA standard WD 6-2021, wherein the receptacle is selected from a list consisting of NEMA type 5-15, NEMA type 14-30, and NEMA type 14-50 receptacles.

10. The EVSE according to claim 9, wherein the input cord comprises a resistor having a value associated with NEMA receptacle type 5-15, 14-30, or 14-50.

11. The EVSE according to claim 9, wherein the input cord comprises a pair of NEMA type 5-15 receptacles.

12. The EVSE according to claim 1, further comprising the vehicle connector and the output cord, wherein a plurality of wires in the output cord connecting the vehicle connector to the output connector consists of a power wire, a neutral wire, a ground wire, and a control pilot signal wire.

13. An input cord configured for use with Electric Vehicle Supply Equipment (EVSE), comprising:
a receptacle conforming to ANSI/NEMA standard WD 6-2021, wherein the receptacle is selected from a list consisting of NEMA type 5-15, NEMA type 14-30, and NEMA type 14-50 receptacles;
an EVSE connector configured to interface with an input connector of the EVSE; and
a resistor connected to the EVSE connector having a value associated with the NEMA type 5-15, NEMA type 14-30, or NEMA type 14-50 receptacles.

14. The input cord according to claim 13, wherein the input cord comprises a pair of NEMA type 5-15 receptacles.

15. A method of delivering electrical power from an electric vehicle to an electrical load external to the electric vehicle using an EVSE, the method comprising:
transmitting a DC control pilot signal from the electric vehicle to the EVSE via an output cord terminated by a vehicle connector;
waking an electronic controller of the EVSE from a dormant state after receiving the DC control pilot signal; and
controlling the EVSE via the electronic controller to receive AC electrical power from the electric vehicle through the output cord and transmit AC electrical power to the electrical load external to the electric vehicle through an input cord terminated by an AC receptacle.

16. The method according to claim 15, further comprising:
determining an input cord configuration based on a voltage level of the DC control pilot signal,
confirming the input cord configuration based on a resistance sensed in the input cord, and
commanding the EVSE to output electrical power through the input cord.

17. The method according to claim 15, further comprising selecting the input cord from a plurality of input cord configurations each having a receptacle conforming to ANSI/NEMA standard WD 6-2021, wherein the receptacle is a NEMA type 5-15, NEMA type 14-30, or NEMA type 14-50 receptacle.

18. The method according to claim 15, wherein only a neutral conductor, a power conductor, a ground conductor, and a control pilot signal conductor of an output cable connecting the EVSE to the electric vehicle are used to deliver the electrical power from the electric vehicle to the electrical load external to the electric vehicle.
